(19) United States
(12) Patent Application Publication
(10) Pub. No.: US 2010/0005825 A1
(43) Pub. Date: Jan. 14, 2010

(54) BOTTLED WATER COOLER WITH OZONE STERILIZING DEVICE

(76) Inventor: George M. Yui, Toronto (CA)

Correspondence Address: HPF, P.O. BOX 4442, CHESTERFIELD, MO, 63006-4442, US

(21) Appl. No.: 12/395,633

(22) Filed: Feb. 28, 2009

(30) Foreign Application Priority Data
Jul. 11, 2008 (CN) 2008-20121255

(51) Int. Cl. B67D 5/62; B67D 5/06; B67D 5/08; B67D 5/64; B01J 7/00; A62B 7/10; B01J 19/12

(52) U.S. Cl. 62/389; 222/185.1; 222/146.6; 222/67; 222/130; 222/639; 422/305; 422/122; 422/186.11

(57) ABSTRACT

Devices and methods for sterilizing bottled water coolers and water dispensed therefrom. According to certain embodiments, the invention includes a bottled water cooler, which comprises a water bottle, an exterior cabinet, a cold tank, a bottle receptacle located on top of the cold tank that is configured to receive the water bottle in an inverted position, and an ozone generator. The ozone generator is capable of dispensing ozone gas within the space located above a volume of water contained within the cold tank, such that the ozone gas will be effective to sterilize the interior portions of the cold tank located above the volume of water.

### CROSS-REFERENCE TO RELATED APPLICATIONS

This application claims priority to, and incorporates by reference, Chinese Patent Application Number 2008-20121255, filed Jul. 11, 2008, under 35 U.S.C. §119(a).

### FIELD OF THE INVENTION

The present invention relates generally to the field of bottled water coolers and, more particularly, to devices and methods for sterilizing bottled water coolers and water dispensed therefrom.

### BACKGROUND OF THE INVENTION

The demand for clean and healthy drinking water is increasing dramatically. The rapid growth in population, and standards of living, across the globe is fueling an incredible demand for devices and methods that enable drinking water, and the containers which hold and dispense drinking water, to be efficiently and safely sterilized. There are certain devices that have been developed which employ the use of ozone gas (O₃) to sterilize water. These currently-available devices, however, suffer from one or more drawbacks. For example, the currently-available devices are typically unable to clean and sterilize bacteria that colonize in the space of above the water level within a water cooler (i.e., the currently-available devices are only able to sterilize the actual water, but not other internal parts of the water tank). The internal area of a water cooler, which exists above the water level, is often the most prone to bacterial colonization. Indeed, the often warm and humid environment that exists on the interior surface of most prior art water coolers is ideal of bacterial growth. The currently-available water coolers are often unable to effectively maintain such area in a sterile condition. In addition, it has been found that some currently-available sterilization methods leave unsafe levels of residual ozone in the drinking water, which can impart an undesirable taste to the drinking water (and, furthermore, can be hazardous to a person's health).

As the following will demonstrate, many of the foregoing problems with currently-available sterilization devices and methods for water coolers are addressed by the present invention.

### SUMMARY OF THE INVENTION

According to certain aspects of the invention, water coolers are provided that include devices and methods for sterilizing the interior portions of such coolers and the water contained therein. For example, in certain embodiments, the bottled water coolers of the present invention comprise a water bottle, an exterior cabinet, a cold tank, a bottle receptacle located on top of the cold tank that is configured to receive the water bottle in an inverted position, and an ozone generator, which may be affixed to an outside portion of the exterior cabinet (or, in certain embodiments, to internal portions of the water cooler). The ozone generator is capable of dispensing ozone gas within a space located above a volume of water contained in the cold tank, such that the ozone gas will be effective to sterilize the interior portions of the cold tank located above the volume of water.

According to further aspects of the invention, additional water coolers are provided that also include devices and methods for sterilizing the interior portions of such coolers and the water contained therein. For example, similar to the embodiments described above, the bottled water coolers comprise a water bottle, an exterior cabinet, a cold tank, a bottle receptacle located on top of the cold tank that is configured to receive the water bottle in an inverted position, and an ozone generator affixed to an outside (or internal) portion of the water cooler. The ozone generator is capable of dispensing ozone gas within the volume of water contained within the cold tank, preferably through an ozone diffuser located within the water, such as at the bottom of the cold tank. According to such embodiments, the ozone diffuser may be comprised of a porous stone or sintered metal.

According to yet further aspects of the present invention, methods of sterilizing the internal surfaces of water coolers, and the water contained therein, are provided. The methods of the present invention encompass, for example, the use and operation of the water coolers and devices associated therewith, as described in the present application. More particularly, the methods generally comprise providing an interior portion of a water cooler, located above water level, with a volume of ozone gas during defined intervals. Alternatively, as described herein, the methods may comprise periodically delivering ozone gas into the volume of water contained within the cold tank of the water cooler, vis-à-vis the ozone diffuser described herein.

The above-mentioned and additional features of the present invention are further illustrated in the Detailed Description contained herein.

### BRIEF DESCRIPTION OF THE FIGURES

FIG. 1: A cross-sectional, side view of an exemplary water cooler of the present invention, which employs the devices and methods for sterilizing the interior surfaces of the water cooler described herein.

FIG. 2: A cross-sectional, side view of the top portion of the water cooler shown in FIG. 1.

FIG. 3: A cross-sectional, side view of another exemplary water cooler of the present invention, which employs the devices and methods for sterilizing the interior surfaces of the water cooler described herein (and, in certain embodiments, the drinking water contained therein).

FIG. 4: A cross-sectional, side view of yet another exemplary water cooler that comprises the devices and employs the methods described herein for sterilizing the interior surfaces of the water cooler (and, in certain embodiments, the drinking water contained therein).

### DETAILED DESCRIPTION OF THE INVENTION

The following will describe in detail several preferred embodiments of the present invention. These embodiments are provided by way of explanation only, and thus, should not unduly restrict the scope of the invention. In fact, those of ordinary skill in the art will appreciate upon reading the present specification and viewing the present drawings that the invention teaches many variations and modifications, and that numerous variations of the invention may be employed, used and made without departing from the scope and spirit of the invention.

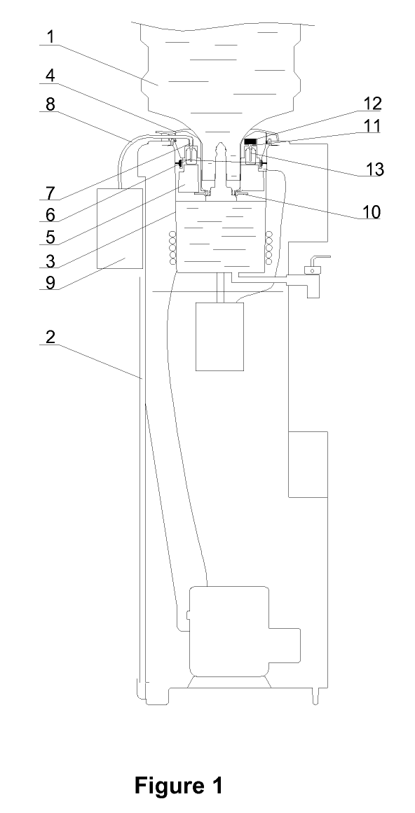

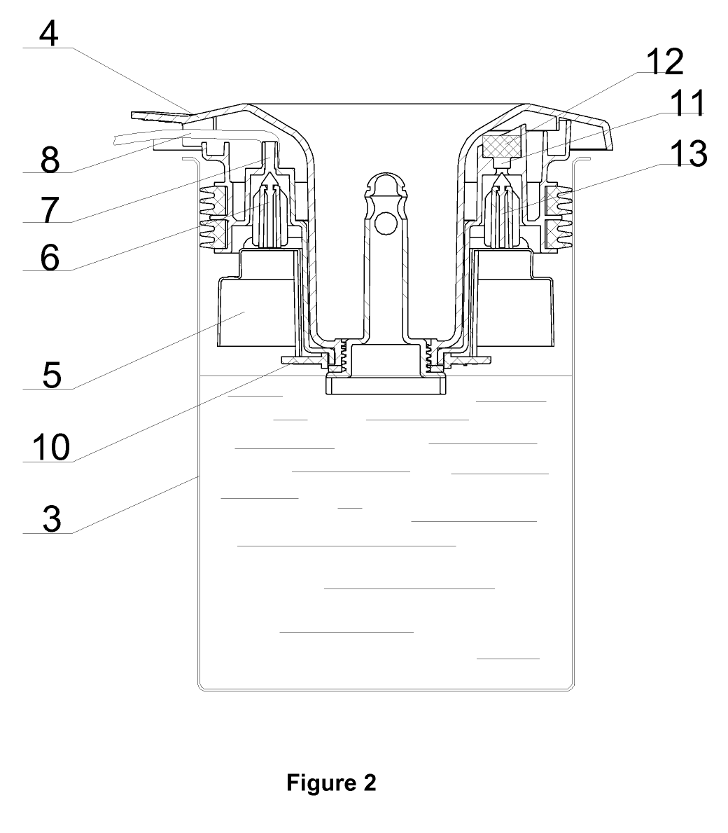

Referring to FIGS. 1 and 2, according to certain embodiments of the present invention, a water cooler is provided that includes a bottle 1, cabinet 2, cold tank 3, bottle receptacle 4 and float 5. The water bottle 1 may exhibit a substantially cylindrical shape, with a dispensing portion thereof comprising a more narrow, neck portion. The invention provides that the bottle 1 may be inverted, with the neck portion (dispensing spout) placed into a bottle receptacle 4, which includes a reservoir or well into which water from the bottle 1 may collect. The cold tank 3 will preferably comprise a means for cooling or chilling the water contained therein, such as by incorporating the use of heat sinks (evaporators) or circulating coolants (refrigerant gasses) along the surfaces thereof. A non-limiting example of such a refrigerant gas includes 134a (tetrafluoroethane). The water cooler further comprises one-way valves (6 and 13) located on each side of the bottle receptacle 4. The one-way valve 6 is fluidly coupled to an ozone vent 7, whereas the one-way valve 13 is fluidly coupled to an air vent 11.

The invention further provides that the ozone vent 7 is fluidly coupled to an ozone generator 9 through an ozone tube 8. The ozone generator 9 is preferably affixed to the outside (exterior portion) of the cooler cabinet 2, as shown in FIG. 1. In certain alternative embodiments, however, the ozone generator 9 may be located within an interior portion of the water cooler. The invention provides that the ozone generator 9 may produce ozone gas (O₃) at a concentration that is effective to kill, or reduce the viable number of, bacteria and/or other microbes. The invention provides that the ozone output may be modulated using devices and techniques well-known in the art, either by the end user (or by the manufacturer of the water cooler). The one-way valve 13, which is fluidly coupled to the air vent 11, will be able to release air from the interior of the cold tank 3 when water is dispensed from the water cooler. The air vent 11 may be coupled to a filter or sponge 12, which may be used to trap, capture, and/or neutralize any ozone gas that may otherwise be released from the interior of the water cooler when water is dispensed therefrom (and to avoid its release into the surrounding air). The filter or sponge 12 may be comprised of any material, or combination of materials, which is capable of sequestering (or neutralizing) ozone gas, such as foam saturated with activated carbon.

The invention provides that ozone may be provided to the cold tank 3 via the ozone tube 8 and ozone vent 7, which will be effective to sterilize the interior walls of the cold tank 3. More specifically, the ozone generator 9 may be activated to provide the released ozone through the ozone tube 8 and ozone vent 7, into the interior portion of the cold tank 3. The ozone vent 7 may be located in a position such that the ozone gas is dispensed above the water level in the cold tank 3 (i.e., at a position above the volume of water contained therein), such that the interior portions of the cold tank 3 are provided with ozone, thereby sterilizing the interior surfaces of the cold tank 3 above the water level. The invention provides that the ozone gas, following its release into the cold tank 3, will form a type of ozone-shield, which will prevent bacterial growth on the susceptible interior portions of the cold tank 3 above water level, as well as the other plastic and silicon parts that may exist close to the interface of the water level, valves, dispensing spigots, and other internal parts of the water cooler.

The invention provides that the ozone gas, once dispensed into the cold tank 3, will break down over time. Accordingly, in order to avoid bacterial growth within the cold tank 3, the ozone generator 9 may comprise a programmable regulator which may be programmed to dispense ozone into the cold tank 3 at defined time points. For example, by way of illustration and not limitation, the ozone generator 9 may comprise a timer, which releases ozone into the cold tank 3 for a specific duration of time and at defined time points, e.g., ozone may be dispensed for 4 seconds every 2 hours, for 4 seconds every 4 hours, for 6 seconds every 4 hours, or any other variation desired. Alternatively, the invention provides that the ozone generator 9 may be programmed to dispense ozone into the cold tank 3 at defined time points, with the time points being defined by the manufacturer (which may not be modified by the end user). According to these embodiments, the manufacturer will be able to determine the appropriate amount of ozone gas to inject into the water cooler, at the specified time points, such that the end user will not be required to make any adjustments (and otherwise deviate from a protocol that the manufacturer has determined to be effective given the configuration and volume of the water cooler, and the concentration of ozone dispensed).

The invention further provides that a baffle ring 10, which may be configured as a large washer, may be disposed at the bottom of the bottle receptacle 4 under a float 5, whereby the outer diameter of the baffle ring 10 is larger than the inner diameter of the float 5. This configuration is effective to prevent the float 5 from falling below the bottom portion of the bottle receptacle 4, and to keep the float 5 and bottom portion of the bottle receptacle 4 in alignment with each other. The float 5 is a buoyant element that rests just above the baffle ring 10, and is configured to be capable of exerting an upward force on and plugging, directly or indirectly, the one-way valves (6 and 13) located on each side of the bottle receptacle 4. In the event that the bottle 1 is damaged and breaks, gravity force will cause the water contained therein to rush into the cold tank 3, thereby quickly raising the water level. The rapid increase in the water level will cause the water to push into the buoyant float 5, which will, in turn, be forced upwards and cause the one-way valves (6 and 13) to be closed, such that water cannot escape through such valves. Accordingly, in the event that the bottle 1 breaks, the foregoing embodiment will prevent water from being pushed into the ozone generator 9 through the one-way valve 6 and ozone tube 8—and prevent water from existing the air vent 11 and onto the floor. As such, the baffle ring 10 maintains the float 5 in the desired resting position, when the water level is below the threshold at which the float 5 should exert an upwards force to plug, directly or indirectly, the one-way valves (6 and 13) located on each side of the bottle receptacle 4.

The invention provides that the float 5 will, preferably, comprise a donut shape. More particularly, the float 5 will exhibit a substantially cylindrical configuration, having an outer diameter and a hole disposed in the middle portion thereof, which exhibits its own diameter. The hole located in the middle of the float 5 will be configured to receive a well of the bottle receptacle 4, which accommodates the neck portion (narrow spout) of the water bottle 1. The outer diameter of the float 5 will preferably be slightly less than the inner diameter of the cold tank 3. For example, by way of illustration and not limitation, if the outer diameter of the float 5 is about 150 mm, the inner diameter of the cold tank 3 may be about 160 mm. Similarly, for example, if the outer diameter of the float 5 is about 125 mm, the inner diameter of the cold tank 3 may be about 140 mm. Accordingly, the invention provides that the outer diameter of the float 5 will preferably be at least 50% of the inner diameter of the cold tank 3 and, more preferably, at least 90% of the inner diameter of the cold tank 3 and, still more preferably, up to 99% of the inner diameter of the cold tank 3.

The invention further provides that the water cooler may comprise a baffle (not shown), which separates the cold tank 3 into an upper and lower section. The purpose of the upper section, created by an intermediate baffle disposed between the upper and lower sections of the cold tank 3, is to receive water (which will be approximately at room temperature) that is dispensed from the neck of the bottle 1 (i.e., the narrow portion of the bottle 1 that is received by the bottle receptacle 4), and to prevent such water from violently disrupting and undesirably warming the cold water contained within the lower section of the cold tank 3 (which is the source of water that is dispensed from the cooler). In addition, having a separate upper and lower section within the cold tank 3 facilitates the diversion of approximately room temperature water from the upper section to a separate hot water dispenser—if desired. This way, if it is desirable to divert water to a separate hot water dispenser, room temperature (instead of cold water) may be diverted from the upper section to the hot water dispenser (which will require less energy to heat, compared to cold water from the lower section of the cold tank 3). The invention provides that pores, vents, or other portals may be located in the baffle, such that water from the upper section may be gradually transferred to the lower section of the cold tank 3, as desired.

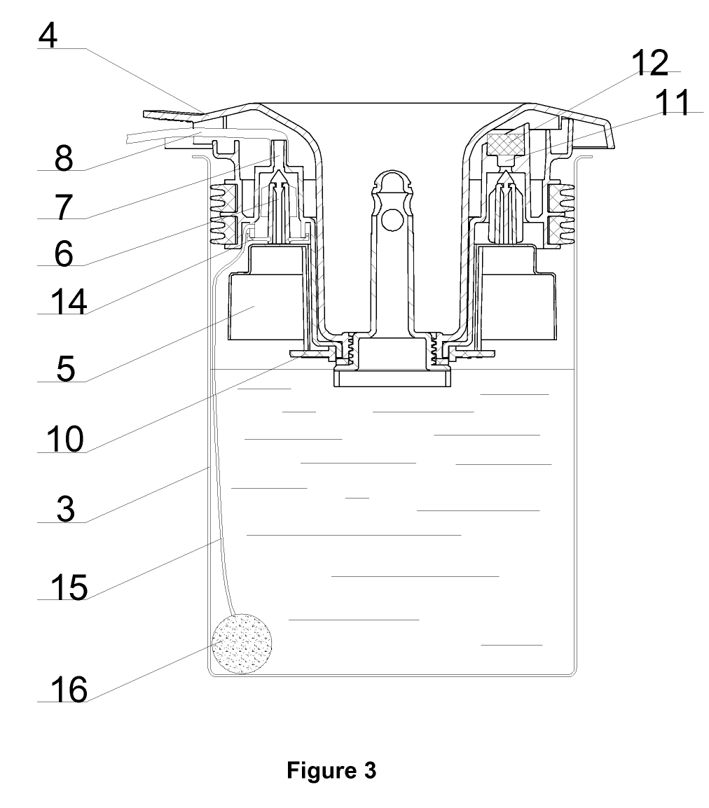

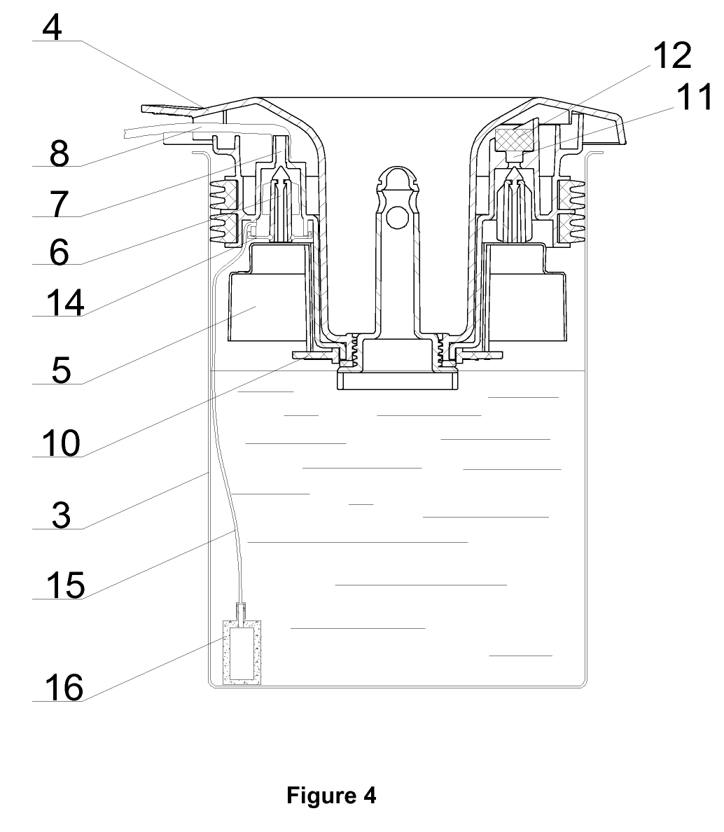

Referring now to FIG. 3, according to certain related embodiments, a vacuum space may be created by disposing an elastic seal 14 between the one-way valve 6 and the bottle receptacle 4. According to this embodiment, the one-way valve 6 is fluidly coupled to an ozone diffuser 16 by a guide hose 15. According to certain embodiments of the present invention, the ozone diffuser 16 may be comprised of porous stone; whereas, in other embodiments of the invention, the ozone diffuser 16 may be comprised of porous sintered metal (as illustrated in FIG. 4). The ozone produced by generator 9 will travel through the vent 7, one-way valve 6, guide hose 15, and will then be diffused into the water through the porous stone (or sintered metal) of the ozone diffuser 16, thereby sterilizing the water contained within the cold tank 3. The ozone gas will also travel upward and be released at water level, and will be able to interact with and sterilize the interior portions of the cold tank 3 located above the water level. According to such embodiments, only minimal and safe levels of ozone are dispensed into the water, in order to ensure that the sterilized water is safe to drink, and will not exhibit an undesirable taste.

According to yet further aspects of the present invention, methods of sterilizing the internal surfaces of water coolers, and the water contained therein, are provided. The methods of the present invention encompass, for example, the use and operation of the water coolers and devices associated therewith, as described in the present application. More particularly, the methods generally comprise providing an interior portion of a water cooler, located above water level, with a volume of ozone gas during defined intervals. Alternatively, as described above, the methods may comprise periodically delivering ozone gas into the volume of water contained within the cold tank of the water cooler, vis-à-vis the ozone diffuser described herein.

The benefits of the water cooler designs and methods of water cooler sterilization described herein, is that the externally (or internally) installed ozone generator will be effective to not only sterilize the cold tank water in certain embodiments, but also the interior water tank surfaces located above the water level. Furthermore, the water coolers and methods described herein improve drinking water hygiene by reducing the amount of ozone gas provided to the drinking water (or at least reducing ozone content below hazardous levels), while effectively sterilizing the drinking water and the critical surfaces and components of the water cooler.

The many aspects and benefits of the invention are apparent from the detailed description, and thus, it is intended for the following claims to cover all such aspects and benefits of the invention which fall within the scope and spirit of the invention. In addition, because numerous modifications and variations will be obvious and readily occur to those skilled in the art, the claims should not be construed to limit the invention to the exact construction and operation illustrated and described herein. Accordingly, all suitable modifications and equivalents should be understood to fall within the scope of the invention as claimed herein.

What is claimed is:

1. A bottled water cooler, which comprises:
(a) a water bottle;
(b) an exterior cabinet;
(c) a cold tank;
(d) a bottle receptacle located on top of the cold tank that is configured to receive the water bottle in an inverted position; and
(e) an ozone generator, which is capable of dispensing ozone gas within a space located above a volume of water contained in the cold tank, wherein the ozone gas is effective to sterilize said space and interior portions of the cold tank located above said volume of water.

2. The bottled water cooler of claim 1, wherein (a) the ozone generator is affixed to an exterior portion of the water cooler and (b) the water cooler further comprises an ozone tube and ozone vent through which the ozone generator dispenses the ozone gas into said space, wherein the ozone vent comprises or is operably connected to a one-way valve that allows ozone gas to be dispensed into, but not out of, the cold tank.

3. The bottled water cooler of claim 2, which further comprises a buoyant float, wherein, if the volume of water contained within the cold tank exceeds a threshold level, the float will cause the one-way valve that allows ozone gas to be dispensed into, but not out of, the cold tank to be closed, such that water will not exit the cold tank through the one-way valve.

4. The bottled water cooler of claim 3, wherein the float comprises an outer diameter and the cold tank comprises an inner diameter, wherein the outer diameter of the float is at least 50% of the inner diameter of the cold tank.

5. The bottled water cooler of claim 4, wherein the outer diameter of the float is up to 99% of the inner diameter of the cold tank.

6. The bottled water cooler of claim 5, wherein the float comprises a substantially circular configuration with a hole located in a middle portion thereof, wherein the hole is configured to receive a well of the bottle receptacle that accommodates a neck portion of the water bottle.

7. The bottled water cooler of claim 6, which further comprises an air vent that is operably connected to a one-way valve, wherein the air vent (1) is adapted to allow air to escape from the cold tank when water is dispensed therefrom and (2) comprises a sponge or filter that is capable of collecting or neutralizing ozone gas from the air, wherein the sponge or filter comprises activated carbon.

8. The bottled water cooler of claim 7, which further comprises a baffle that separates a first volume of cold water contained in the cold tank from a second volume of room temperature water that is released from the water bottle.

9. The bottled water cooler of claim 8, which further comprises a baffle ring that is located beneath the float, wherein (1) the baffle ring comprises an outer diameter that is larger than an inner diameter of the float and (2) the baffle ring is effective to prevent the float from falling below the bottom portion of the bottle receptacle.

10. The bottled water cooler of claim 9, wherein the ozone generator dispenses ozone into the cold tank at defined time intervals.

11. A bottled water cooler, which comprises:
(a) a water bottle;
(b) an exterior cabinet;
(c) a cold tank;
(d) a bottle receptacle located on top of the cold tank that is configured to receive the water bottle in an inverted position; and
(e) an ozone diffuser located within a volume of water contained within the cold tank, wherein the ozone diffuser is fluidly coupled to an ozone generator through a guide hosel and a one-way valve, wherein the ozone generator is capable of dispensing ozone gas within the volume of water through the ozone diffuser, wherein the ozone gas is effective to sterilize the water and interior portions of the cold tank located above the volume of water.

12. The bottled water cooler of claim 11, which further comprises a buoyant float, wherein, if the volume of water contained within the cold tank exceeds a threshold level, the float will cause the one-way valve that allows ozone gas to be dispensed into, but not out of, the cold tank to be closed, such that water will not exit the cold tank through the one-way valve.

13. The bottled water cooler of claim 12, wherein the float comprises an outer diameter and the cold tank comprises an inner diameter, wherein the outer diameter of the float is at least 50% of the inner diameter of the cold tank.

14. The bottled water cooler of claim 13, wherein the outer diameter of the float is up to 99% of the inner diameter of the cold tank.

15. The bottled water cooler of claim 14, wherein the float comprises a substantially circular configuration with a hole located in a middle portion thereof, wherein the hole is configured to receive a well of the bottle receptacle that accommodates a neck portion of the water bottle.

16. The bottled water cooler of claim 15, which further comprises an air vent that is operably connected to a one-way valve, wherein the air vent (1) is adapted to allow air to escape from the cold tank when water is dispensed therefrom and (2) comprises a sponge or filter that is capable of collecting or neutralizing ozone gas from the air, wherein the sponge or filter comprises activated carbon.

17. The bottled water cooler of claim 16, which further comprises a baffle that separates a first volume of cold water contained in the cold tank from a second volume of room temperature water that is released from the water bottle.

18. The bottled water cooler of claim 17, which further comprises a baffle ring that is located beneath the float, wherein (1) the baffle ring comprises an outer diameter that is larger than an inner diameter of the float and (2) the baffle ring is effective to prevent the float from falling below the bottom portion of the bottle receptacle.

19. The bottled water cooler of claim 18, wherein the ozone diffuser is comprised of porous stone or porous sintered metal.

20. The bottled water cooler of claim 19, wherein the ozone generator dispenses ozone into the cold tank at defined time intervals.
